(19) United States
(12) Patent Application Publication
(10) Pub. No.: US 2016/0162635 A1
(43) Pub. Date: Jun. 9, 2016

(54) METHOD AND SYSTEM FOR DETERMINING A BACTERIAL RESISTANCE TO AN ANTIBIOTIC DRUG

(71) Applicants: Siemens Aktiengesellschaft, München (DE); SIEMENS HEALTHCARE DIAGNOSTICS INC., Tarrytown, NY (US)

(72) Inventors: Andreas KELLER, Püttlingen (DE); Cord Friedrich STÄHLER, Hirschberg an der Bergstraße (DE); Gabriel RENSEN, Ukiah, CA (US)

(73) Assignee: Siemens Aktiengesellschaft, München (DE)

(21) Appl. No.: 14/905,014

(22) PCT Filed: Jun. 25, 2014
(86) PCT No.: PCT/EP2014/063431

§ 371 Date: Jan. 14, 2016

(30) Foreign Application Priority Data
Jul. 17, 2013 (EP) 13176850.9

(51) Int. Cl. G06F 19/22; G06F 19/18

(52) U.S. Cl. CPC G06F 19/22; G06F 19/18

(57) ABSTRACT

The invention relates to a method, a databank, a system and a computer program product for determining a bacterial resistance to an antibiotic drug. A data bank is provided which comprises a plurality of bacterial reference nucleic acid sequences, wherein at least some reference nucleic acid sequences are associated with a respective antibiotic drug resistance information. A comparison unit is used for comparing said bacterial nucleic acid sequence information obtained from a sample with said plurality of bacterial reference nucleic acid sequences.

### PRIORITY STATEMENT

This application is the national phase under 35 U.S.C. §371 of PCT International Application No. PCT/EP2014/063431 which has an International filing date of 25 Jun. 2014, which designated the United States of America, and which claims priority to European patent application number EP 13176850.9 filed 17 Jul. 2013. The entire contents of each applications recited above are hereby incorporated herein by reference.

### FIELD

The invention generally relates to a method, a databank, a system and/or a computer program product for determining a bacterial resistance to an antibiotic drug.

### BACKGROUND

For many human infections it is essential to know the bacterium which is causative for infection as early as possible since symptoms may be similar between different specimens while the cause and the treatment of the infection may vary greatly.

It would be even more important to know potential resistance and susceptibility profiles of certain bacteria immediately with the diagnosis, a great challenge given the complexities of antibiotic resistance ranging from multiple factors to variation at the single nucleotide level.

Thus, classical microbiology piecewise migrates to molecular microbiology.

Diagnosis of bacteria can be done using different approaches, the gold standard being isolation and growth of bacterial strains, which is time consuming. For antibiotic susceptibility testing (AST), the situation is even less satisfactory. Here, bacteria are incubated with different anti-bacterial agents and the growth of the bacteria is observed: growth in the presence of increasing concentration of antibacterial agents, the higher the resistance. Obviously, this process takes time, a routine diagnosis takes around 32-48 hours after consulting a physician.

For viruses, it is known to apply sequencing in order to predict resistance and propose a single drug or combination therapy, see e.g. U.S. Pat. No. 8,278,432 B2 or WO 2006130449 A2. Together with advanced therapies this approach has lead to steadily increasing survival times for HIV infected patients such that HIV can be turned into a chronic disease via medical treatment.

Due to virus genome size, the content of genetic information for viruses, however, is dramatically smaller than for bacteria such that classical sequencing approaches could not be applied to solve this complex problem for determining bacterial drug resistance.

### SUMMARY

Methods and systems for determining a bacterial resistance to an antibiotic drug are provided herein.

An embodiment of the invention relates to a method for determining a bacterial resistance to an antibiotic drug, comprising the steps:

obtaining a bacterial nucleic acid sequence from a sample;
comparing the bacterial nucleic acid sequence from said sample with a reference nucleic acid sequence, wherein said reference nucleic acid sequence is associated with an antibiotic drug resistance information; and
determining bacterial resistance to an antibiotic drug based on said comparison in step (b).

According to an aspect of an embodiment of the invention said reference nucleic acid sequence is stored in a data bank and step (b) comprises querying said data bank.

The comparison step (b) may comprise determining the similarity between the bacterial nucleic acid sequence from said sample and the reference nucleic acid sequence. Similarity of nucleic acid sequences may be determined using established algorithms such as FASTA and others as is known in the art.

According to an aspect of an embodiment of the invention step (b) further comprises comparing said bacterial nucleic acid sequence from said sample with a plurality of reference nucleic acid sequences and determining a similarity of the bacterial nucleic acid sequence from said sample with each of the of reference nucleic acid sequences.

According to an aspect of an embodiment of the invention step (b) further comprises determining which reference nucleic acid sequence of said plurality of reference nucleic acid sequences has the greatest similarity with said bacterial nucleic acid sequence from said sample and wherein step (c) further comprises determining bacterial resistance to an antibiotic drug based on antibiotic drug resistance information associated with the reference nucleic acid sequence having the greatest similarity to said bacterial nucleic acid sequence from said sample.

According to an aspect of an embodiment of the invention the data bank is at a remote location and is queried from a local client.

According to an aspect of an embodiment of the invention after step (c) the bacterial nucleic acid sequence from said sample is recorded and stored as new reference nucleic acid sequence.

According to an aspect of an embodiment of the invention the bacterial nucleic acid is selected from the group of genomic sequence, plasmid sequence, and bacteriophage sequence.

According to an aspect of an embodiment of the invention the bacterial nucleic acid sequence from said sample is obtained by a next generation sequencing method.

An embodiment of the invention further relates to a data bank, comprising a plurality of bacterial reference nucleic acid sequences, wherein at least some reference nucleic acid sequences are associated with a respective antibiotic drug resistance information.

According to an aspect of an embodiment of the invention at least some reference nucleic acid sequences are associated with a respective clinical data information.

According to an aspect of an embodiment of the invention at least some reference nucleic acid sequences are associated with a respective bacterial origin information.

An embodiment of the invention further relates to a system for performing the methods of the invention, comprising
a memory including a data bank a plurality of bacterial reference nucleic acid sequences being stored in the data bank, wherein at least some of the plurality of bacterial reference nucleic acid sequences are respectively associated with respective antibiotic drug resistance information; and
a processor to compare bacterial nucleic acid sequence information obtained from a sample with said plurality of bacterial reference nucleic acid sequences, the processor further being configured to output information about bacterial resistance to an antibiotic drug based on the comparison information.

The invention further relates to a non-transitory computer readable medium, loadable into a programmable computer and including program code segments for performing an embodiment of the method, when the computer program segments are executed on said programmable computer.

According to an aspect of the invention said computer program product may comprise
a device for receiving bacterial nucleic acid sequence information obtained from a sample;
   a comparison unit for comparing said bacterial nucleic acid sequence information obtained from a sample with said plurality of bacterial reference nucleic acid sequences; and
a device for outputting information about bacterial resistance to an antibiotic drug based on comparison information provided by the comparison unit.

### BRIEF DESCRIPTION OF THE DRAWINGS

FIG. 1 shows a systematic diagram of an example embodiment of the system of the invention.

### DETAILED DESCRIPTION

### Definitions

Unless defined otherwise, technical and scientific terms used herein have the same meaning as commonly understood by one of ordinary skill in the art to which this invention belongs.

The term “nucleic acid” refers to a polynucleotide molecule having a defined sequence. It comprises DNA molecules, RNA molecules, nucleotide analog molecules and combinations thereof, such as DNA molecules or RNA molecules with incorporated nucleotide analogs.

In the context of the present invention, “antibiotic drug resistance” refers to a drug resistance wherein at least some sub-populations of a bacterial species are able to survive after exposure the antibiotic drug.

The term “antibiotic drug resistance information” relates to any information regarding to susceptibility or resistance of a bacterial organism to a given antibiotic drug and may include information about dose-related response to the antibiotic drug such as minimal inhibitory dose, effective dose, ED50 concentration or the like.

In the context of the present invention, “bacterial nucleic acid sequence” means a nucleic acid sequence comprised in or derived from a bacterial organism. Examples for the term “bacterial nucleic acid sequence” include the entire bacterial genomic sequence or a part thereof, bacterial mRNA or a part thereof, miRNA or a part thereof, plasmid sequence or a part thereof, cDNA derived from bacterial RNA, and bacteriophage sequence or a part thereof.

In the context of the present invention, “reference nucleic acid sequence” means a nucleic acid sequence with a known sequence. In the context of the present invention, the reference nucleic acid sequence may optionally be associated with further information such as bacterial origin information, clinical data information, or antibiotic drug resistance information. Examples for the term “reference nucleic acid sequence” include a known entire bacterial genomic sequence or a part thereof, a known plasmid sequence or a part thereof, and a known bacteriophage sequence or a part thereof.

The term “sample” refers any sample suspected of containing bacteria or fragments of bacteria. Examples for the term “sample” include liquid sample, swab sample, tissue sample, in particular a patient sample such as body fluid sample, lavage sample, swab sample, tissue sample, blood sample, urine sample, saliva sample, stool sample, plasma sample, serum sample, cerebro-spinal fluid sample and others.

A “miRNA” is a short, naturally occurring RNA molecule and shall have the ordinary meaning understood by a person skilled in the art. A “molecule derived from an miRNA” is a molecule which is chemically or enzymatically obtained from an miRNA template, such as cDNA.

The term “next generation sequencing” or “high throughput sequencing” refers to high-throughput sequencing technologies that parallelize the sequencing process, producing thousands or millions of sequences at once. Examples include Massively Parallel Signature Sequencing (MPSS) Polony sequencing, 454 pyrosequencing, Illumina (Solexa) sequencing, SOLiD sequencing, Ion semiconductor sequencing, DNA nanoball sequencing, Helioscope™ single molecule sequencing, Single Molecule SMRT™ sequencing, Single Molecule real time (RNAP) sequencing, Nanopore DNA sequencing.

The term “clinical data” or “clinical data information” relates to any information comprised in the entirety of available data and information concerning the health status of a patient including, but not limited to, age, sex, weight, menopausal/hormonal status, etiopathology data, anamnesis data, data obtained by in vitro diagnostic methods such as blood or urine tests, data obtained by imaging methods, such as x-ray, computed tomography, MRI, PET, spect, ultrasound, electrophysiological data, genetic analysis, gene expression analysis, biopsy evaluation, intraoperative findings.

The term “bacterial origin information” relates to any information comprised in the entirety of available data and information concerning the origin of bacteria within the bacterial domain such as kingdom, phylum, class, order, family, genus, species, subspecies, subtype, isolate information, information including geographic origin and host origin, including patient data.

The invention relates to a method for determining a bacterial resistance to an antibiotic drug, comprising the steps:

obtaining a bacterial nucleic acid sequence from a sample;
comparing the bacterial nucleic acid sequence from said sample with a reference nucleic acid sequence, wherein said reference nucleic acid sequence is associated with an antibiotic drug resistance information; and
determining bacterial resistance to an antibiotic drug based on said comparison in step (b).

According to an aspect of the invention said reference nucleic acid sequence is stored in a data bank and step (b) comprises querying said data bank.

The comparison step (b) may comprise determining the similarity between the bacterial nucleic acid sequence from said sample and the reference nucleic acid sequence. Similarity of nucleic acid sequences may be determined using established algorithms such as FASTA and others as is known in the art.

According to an aspect of the invention step (b) further comprises comparing said bacterial nucleic acid sequence from said sample with a plurality of reference nucleic acid sequences and determining a similarity of the bacterial nucleic acid sequence from said sample with each of the of reference nucleic acid sequences.

According to an aspect of the invention step (b) further comprises determining which reference nucleic acid sequence of said plurality of reference nucleic acid sequences has the greatest similarity with said bacterial nucleic acid sequence from said sample and wherein step (c) further comprises determining bacterial resistance to an antibiotic drug based on antibiotic drug resistance information associated with the reference nucleic acid sequence having the greatest similarity to said bacterial nucleic acid sequence from said sample.

According to an aspect of the invention the data bank is at a remote location and is queried from a local client.

According to an aspect of the invention after step (c) the bacterial nucleic acid sequence from said sample is recorded and stored as new reference nucleic acid sequence.

According to an aspect of the invention the bacterial nucleic acid is selected from the group of genomic sequence, plasmid sequence, and bacteriophage sequence.

According to an aspect of the invention the bacterial nucleic acid sequence from said sample is obtained by a next generation sequencing method.

The invention further relates to a data bank, comprising a plurality of bacterial reference nucleic acid sequences, wherein at least some reference nucleic acid sequences are associated with a respective antibiotic drug resistance information.

According to an aspect of the invention at least some reference nucleic acid sequences are associated with a respective clinical data information.

According to an aspect of the invention at least some reference nucleic acid sequences are associated with a respective bacterial origin information.

The invention further relates to a system for performing the methods of the invention, comprising

a memory including a data bank, a plurality of bacterial reference nucleic acid sequences being stored in the data bank, wherein at least some of the plurality of bacterial reference nucleic acid sequences are respectively associated with a respective antibiotic drug resistance information; and
a processor to compare said bacterial nucleic acid sequence information obtained from a sample with said plurality of bacterial reference nucleic acid sequences, the processor further being configured to output information about bacterial resistance to an antibiotic drug based on comparison information.

The invention further relates to a non-transitory computer readable medium, loadable into a programmable computer and including program code segments for performing an embodiment of the method, when the computer program segments are executed on said programmable computer.

According to an aspect of the invention said computer program product may comprise
a device for receiving bacterial nucleic acid sequence information obtained from a sample;
a comparison unit for comparing said bacterial nucleic acid sequence information obtained from a sample with said plurality of bacterial reference nucleic acid sequences; and
a device for outputting information about bacterial resistance to an antibiotic drug based on comparison information provided by the comparison unit.

Additional details, features, characteristics and advantages of the invention are further disclosed in the following description and figures of the respective examples, which, in an exemplary fashion, show preferred embodiments of the present invention. However, these examples should by no means be understood as to limit the scope of the invention.

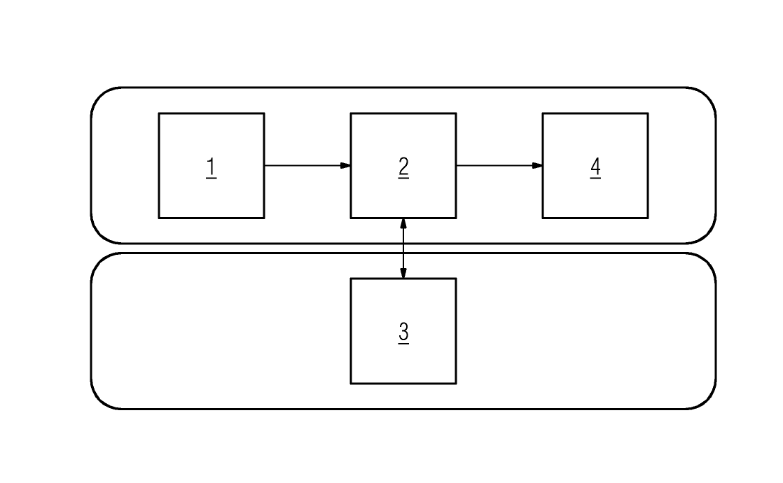

In FIG. 1, an exemplary embodiment of the system for performing the methods of the invention comprises a local client (1, 2, 4) and a remote data bank (3) having stored a plurality of bacterial reference nucleic acid sequences, wherein at least some reference nucleic acid sequences are associated with a respective antibiotic drug resistance information. The local client comprises means (1) for entering or receiving bacterial nucleic acid sequence information obtained from a sample—this bacterial nucleic acid sequence information can for example be inputted at a local client to the means (1) for receiving bacterial nucleic acid sequence information. This can be done by an operator, e.g. via a keyboard, or by importing sequence information data directly from a sequencing device, from a data storage medium, e.g. hard drive, solid state, etc, or via a suitable data link. The system further includes a comparison unit (2) for comparing said bacterial nucleic acid sequence information obtained from a sample with said plurality of bacterial reference nucleic acid sequences. The reference nucleic acid sequences are remotely stored in a data bank (3). The data can be obtained from the data bank via any suitable data transfer, e.g. local network, wireless, or internet based. The data bank (3) can further provide antibiotic resistance information associated with the reference nucleic acid sequence.

According to an exemplary embodiment the comparison unit (2) can compare said bacterial nucleic acid sequence from said sample with a plurality of reference nucleic acid sequences and determine the similarity of the bacterial nucleic acid sequence from said sample with each of the of reference nucleic acid sequences. It can then determine which reference nucleic acid sequence of said plurality of reference nucleic acid sequences has the greatest similarity with said bacterial nucleic acid sequence from said sample. According to this exemplary embodiment, the resistance to an antibiotic drug is determined based on antibiotic drug resistance information associated with the reference nucleic acid sequence having the greatest similarity to said bacterial nucleic acid sequence from said sample.

The system further includes means (4) for outputting information about bacterial resistance to an antibiotic drug based on comparison information provided by the comparison unit (2). This can be outputted via any suitable means, e.g. as visual information on screen, in printed form, by e-mail, SMS and/or by data transfer to a remote location.

The system may comprise a computer program product which can be run locally on the local client. The computer program product can comprise means (1) for receiving bacterial nucleic acid sequence, a comparison unit (2) and the means (4) for outputting information about bacterial resistance to an antibiotic drug based on comparison information, e.g. by sending such information to a suitable data recipient, such as a display device, printer, e-mail account or the like.

The data bank (3) can optionally further comprise clinical data information and/or bacterial origin information associated with a reference nucleic acid sequence.

According to an alternative embodiment the comparison unit is provided remotely at the site of the data bank and the local client is just used for entering information and receiving results (not shown).

According to an example, a reference nucleic acid sequence may be a known nucleic acid sequence of a beta-lactamase gene which encodes for a beta-lactamase enzyme which in turn confers antibiotic drug resistance to the antibiotic penicillin G. Thus, the reference nucleic acid sequence is associated with antibiotic resistance information regarding resistance to the antibiotic penicillin G. The reference nucleic acid sequence may further be associated with bacterial origin information, e.g. strain or sub strain information. The reference nucleic acid sequence may further be associated with clinical date information, e.g. information regarding the treatment and outcome of the patient whom the reference nucleic acid sequence was isolated and obtained from.

With high-throughput sequencing (next generation sequencing, NGS) a knowledge-sample data bank can be set up with moderate effort. It would for example include a) a data bank with a significant amount of bacterial/clinical isolates and a database containing the information pair: complete antibiogram with true MIC of bacteria together with genetic sequence. This self-learning database is filled with genomes of different strains of bacteria. Correlation approaches are applied in order to understand resistance mechanisms of bacteria and to predict which therapy is best suited for a new patient. We estimate that around 20,000-35,000 bacterial genomes have to be included in the database initially. The data bank is of importance in case of novel therapies. Bacteria from that data bank can be tested against the new therapy with moderate effort in order to gain information on the efficiency of that therapy. This adds not only value to the diagnosis of single patients but also offers a viable source for pharma companies.

Besides the genetic information resistance mechanisms are likely also influenced by regulatory effects. Here, one key element are small non-coding RNAs (miRNAs). Thus the regulatory role of miRNAs in the light of resistance mechanisms will be included in our model. Here, miRNAs in bacteria as well as miRNAs in the bloodstream of patients are identified and put in the same context as the descriptive genetic information.

1. A method for determining a bacterial resistance to an antibiotic drug, comprising the steps:
a) obtaining a bacterial nucleic acid sequence from a sample;
b) comparing the bacterial nucleic acid sequence from said sample with a reference nucleic acid sequence, wherein said reference nucleic acid sequence is associated with a respective antibiotic drug resistance information; and
c) determining bacterial resistance to an antibiotic drug based on said comparison in step (b).

2. The method according to claim 1, wherein said reference nucleic acid sequence is stored in a data bank and wherein step (b) comprises querying said data bank.

3. The method according to claim 1, wherein step (b) comprises determining the similarity between the bacterial nucleic acid sequence from said sample and the reference nucleic acid sequence.

4. The method according to claim 3, wherein step (b) further comprises comparing said bacterial nucleic acid sequence from said sample with a plurality of reference nucleic acid sequences and determining a similarity of the bacterial nucleic acid sequence from said sample with each of the of reference nucleic acid sequences.

5. The method according to claim 4, wherein step (b) further comprises determining which reference nucleic acid sequence of said plurality of reference nucleic acid sequences has the greatest similarity with said bacterial nucleic acid sequence from said sample and wherein step (c) further comprises determining bacterial resistance to an antibiotic drug based on antibiotic drug resistance information associated with the reference nucleic acid sequence having the greatest similarity to said bacterial nucleic acid sequence from said sample.

6. The method according to claim 2, wherein the data bank is at a remote location and is queried from a local client.

7. The method according to claim 1, wherein after step (c) the bacterial nucleic acid sequence from said sample is recorded and stored as new reference nucleic acid sequence.

8. The method according to claim 1, wherein the bacterial nucleic acid is selected from the group of genomic sequence, plasmid sequence and bacteriophage sequence.

9. The method according to claim 1, wherein the bacterial nucleic acid sequence from said sample is obtained by a next generation sequencing method.

10. A data bank, comprising a plurality of bacterial reference nucleic acid sequences, wherein at least some reference nucleic acid sequences are associated with respective antibiotic drug resistance information.

11. The databank according to claim 10, wherein at least some reference nucleic acid sequences are associated with respective clinical data information.

12. The databank according to claim 10, wherein at least some reference nucleic acid sequences are associated with respective bacterial origin information.

13. A system, comprising
a memory including a data bank, a plurality of bacterial reference nucleic acid sequences being stored in the data bank, wherein at least some of the plurality of bacterial reference nucleic acid sequences are respectively associated with respective antibiotic drug resistance information;
a processor to compare bacterial nucleic acid sequence information obtained from a sample with said plurality of bacterial reference nucleic acid sequences, the processor further being configured to output information about bacterial resistance to an antibiotic drug based on the comparison information.

14. A non-transitory computer readable medium, loadable into a programmable computer and including program code segments for performing the method according to claim 1, when the computer program segments are executed on said programmable computer.

15. (canceled)

16. The method according to claim 2, wherein step (b) comprises determining the similarity between the bacterial nucleic acid sequence from said sample and the reference nucleic acid sequence.

17. The method according to claim 16, wherein step (b) further comprises comparing said bacterial nucleic acid sequence from said sample with a plurality of reference nucleic acid sequences and determining a similarity of the bacterial nucleic acid sequence from said sample with each of the of reference nucleic acid sequences.

18. The method according to claim 17, wherein step (b) further comprises determining which reference nucleic acid sequence of said plurality of reference nucleic acid sequences has the greatest similarity with said bacterial nucleic acid sequence from said sample and wherein step (c) further comprises determining bacterial resistance to an antibiotic drug based on antibiotic drug resistance information associated with the reference nucleic acid sequence having the greatest similarity to said bacterial nucleic acid sequence from said sample.

19. The method according to claim 3, wherein the data bank is at a remote location and is queried from a local client.

20. The method according to claim 2, wherein after step (c) the bacterial nucleic acid sequence from said sample is recorded and stored as new reference nucleic acid sequence.

21. The databank according to claim 11, wherein at least some reference nucleic acid sequences are associated with respective bacterial origin information.
